(19) United States
(12) Patent Application Publication
(10) Pub. No.: US 2026/0241539 A1
(43) Pub. Date: Aug. 20, 2026

(54) KEY HOLDER

(71) Applicant: STANLEY BLACK & DECKER MEA FZE, Dubai (AE)

(72) Inventor: Kaixuan Wei, Taichung City (TW)

(21) Appl. No.: 19/644,095

(22) Filed: Apr. 10, 2026

Related U.S. Application Data
(63) Continuation of application No. 18/334,921, filed on Jun. 14, 2023, now Pat. No. 12,617,070.

(30) Foreign Application Priority Data
Jun. 17, 2022 (EP) 22179535.4

(51) Int. Cl. B25H 3/00

(52) U.S. Cl. CPC B25H 3/003

(57) ABSTRACT

The present invention relates to a key holder for a set of graduated keys such as hexagonal (hex) or Allen keys. The key holder includes two or more segments each having at least one opening for receiving a key. The holder further includes a hinge that is configured to permit the movement of adjacent segments between and aligned position and an unaligned position. In the aligned position, the removal of the smaller of two graduated keys is blocked when said keys are in the openings of adjacent segments and are positioned in the same direction. In the unaligned position, graduated keys in adjacent segments are perpendicular to one another and the smaller key can be removed without interference from the larger key.

### CROSS-REFERENCE TO RELATED APPLICATIONS

This application is a continuation of U.S. patent application Ser. No. 18/334,921, filed Jun. 14, 2023, which claims priority to EP Patent Application No. 22179535.4, filed on Jun. 17, 2022, which is incorporated herein by reference in its entirety.

### FIELD OF THE INVENTION

The present invention relates to a key holder. More specifically, the invention relates to a key holder that permits the orderly and easy removal of said keys.

### BACKGROUND OF THE INVENTION

Keys, such as hexagonal (hex) or Allen type keys are well-known tools that are useful for a variety of different torquing jobs. These keys (or wrenches) are typically purchased in a graduated set within a holder, wherein each key is slightly larger (or smaller) than the one immediately next to it. Moreover, the keys are typically bent such that one portion of the key is in a different plane from a second portion. Keys within a holder are often positioned facing the same direction such that the bent portion of the larger key is cantilevered over the bent portion of its immediate neighbor. This arrangement often makes for an orderly and compact presentation of the set of keys.

While it is advantageous to have a full set of keys to permit an operator to tackle a variety of jobs, the cantilevered nature of their positioning within a holder often causes frustration when it comes time to use a key. The larger keys can block or limit the removal of smaller keys from the holder. If an operator needs to use any key other than the largest one, she often needs to remove several other keys before she can remove the desired key. This is an unnecessary waste of time. It would be advantageous to have a key holder that provides a compact orderly presentation of the graduated keys and simultaneously permits the removal of a desired key without the need to remove any other keys.

### SUMMARY OF THE INVENTION

According to an aspect of the invention, a holder for a plurality of graduated keys, said holder having two or more segments each defining at least one opening therethrough. Each of said openings is configured to receive one of a series of graduated keys and selectively secure said key therein. The holder is characterized in that it further includes a hinge connecting adjacent segments. The hinge is configured to permit movement of the adjacent segments between an aligned position and an unaligned position. In the aligned position, the removal of the smaller of two graduated keys is blocked when said keys are in the openings of adjacent segments and are positioned in the same direction. In the unaligned position, graduated keys in adjacent segments are perpendicular to one another and the smaller key can be removed without interference from the larger key.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein, “connected” or “attached” includes physical or electrical, whether direct or indirect, affixed or adjustably mounted. Thus, unless specified, “connected” or “attached” is intended to embrace any operationally functional connection. When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and approaching or approximating such a physical or functional characteristic.

In the following description, reference is made to the accompanying attachments and drawings which are provided for descriptive and illustration purposes as representative of specific exemplary embodiments in which the invention may be practiced. Given the following description of the specification and drawings, the apparatus, methods, and systems should become evident to a person of ordinary skill in the art. Further areas of applicability of the present teachings will become apparent from the description and illustrations provided herein. It is to be understood that other embodiments can be utilized and that structural changes based on presently known structural and/or functional equivalents can be made without departing from the scope of the invention.

### BRIEF DESCRIPTION OF THE DRAWINGS

The above-mentioned and other features, embodiments, and advantages of this invention, and the manner of attaining them, will become more apparent and the invention will be better understood by reference to the following descriptions of embodiments of the invention taken in conjunction with the accompanying drawings, wherein:

FIG. 1a illustrates perspective view of the key holder in its aligned position;

FIG. 1b illustrates an alternate perspective view of the key holder in its unaligned position;

FIG. 2a illustrates a perspective view of the key holder with a full set of graduated keys, and wherein the key holder is in its aligned position;

FIG. 2b illustrates an alternate perspective view of the key holder with a full set of graduated keys, and wherein the key holder is in its unaligned position;

FIG. 3a illustrates a perspective view of a second embodiment of the key holder in its aligned position;

FIG. 3b illustrates a perspective view of a third embodiment of the key holder in its aligned position; and

FIG. 3c illustrates a perspective view of a fourth embodiment of the key holder in its aligned position.

Corresponding illustrated images and attachments indicate corresponding parts throughout the several views of the present invention. The exemplifications set out herein illustrate embodiments of the present invention, and such exemplifications are not to be construed as limiting the scope of the present invention in any manner.

These and other features of the invention will become apparent upon review of the following description of the presently preferred embodiments of the invention, taken into conjunction with the figures.

### DETAILED DESCRIPTION OF THE ILLUSTRATED EMBODIMENT(S)

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

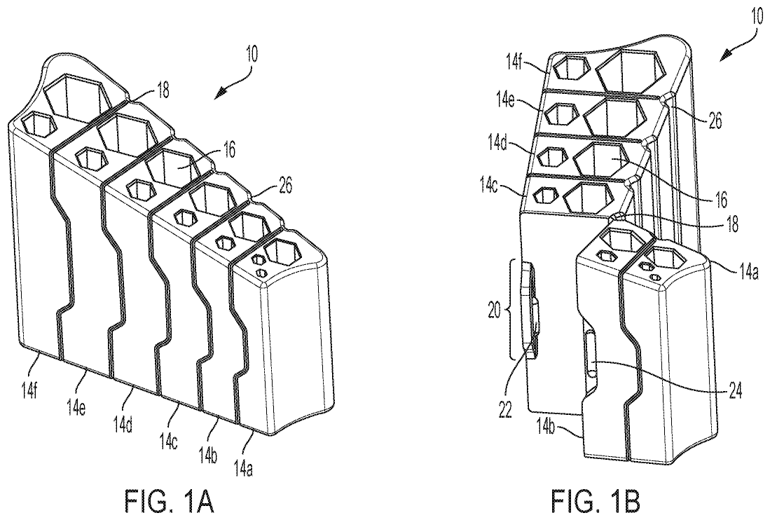

FIGS. 1a and 1b depict alternate perspective view of a key holder 10 according to the present invention. The holder includes two or more segments 14a-f each defining at least one opening 16 therethrough. Each of said openings 16 is configured to receive one of a series of graduated keys. As shown in the figures, said openings may be hexagonally shaped and configured to receive a hexagonal (hex) or Allen type key. However, those skilled in the art will recognize that the openings may be of any shape and configured to receive a corresponding tool of the same shape.

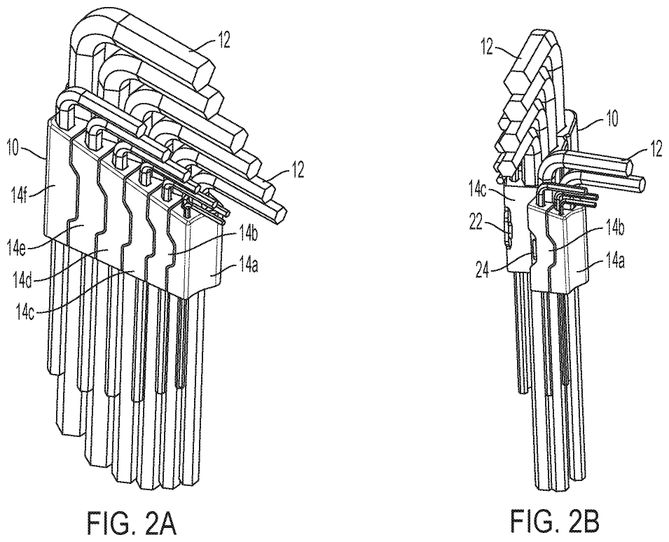

The holder 10 also includes a hinge 18 that connects adjacent segments 14a-f. The hinge 18 is configured to permit movement of the adjacent segments between an aligned position (see FIG. 1a) and an unaligned position (see FIG. 1b). In the aligned position, the removal of the smaller of two graduated keys 12 is blocked when said keys are in the openings of adjacent segments and are positioned in the same direction. In other words, the bent portion of the larger key is cantilevered over the bent portion of the smaller key in the adjacent segment. See FIG. 2a. In the unaligned position, the bent portions of graduated keys in adjacent segments are perpendicular to one another and the smaller key can be removed without interference from the larger key. See FIG. 2b.

Those skilled in the art will recognize that a wide variety of connecting hinges 18 may be employed. For example, as depicted in FIG. 1b, the hinge 18 may be integrated directly into the segments. In other words, the segments 14a-f of holder 10 may be formed from a single piece of material, and the hinge 18 may be a thin connecting portion. In a preferred embodiment, the edges 26 of the segments 14a-f adjacent the hinge 18 may be beveled. See FIG. 1b. Such beveling functions to prevent overbending the segments, which, over time, could weaken the hinge 18.

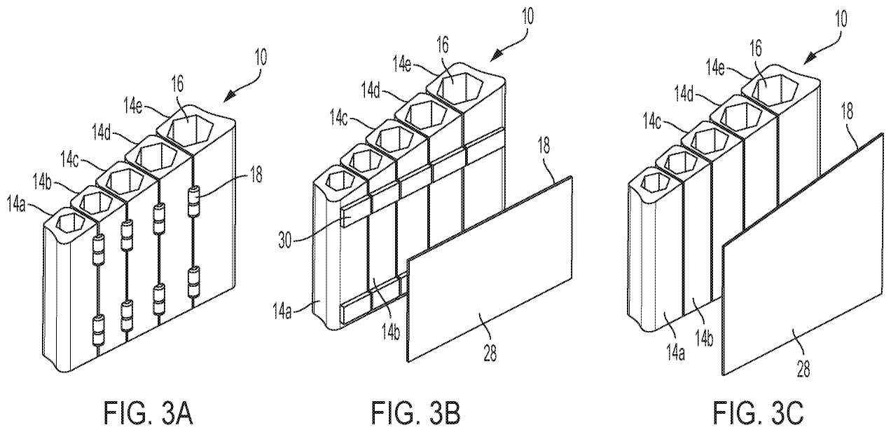

In an alternate embodiment, the hinge 18 could also be a bearing hinge. See FIG. 3a. In yet further alternative embodiments, the hinge 18 could be formed from a single piece of flexible material 28 adhered to the segments. Said adherence can be achieved in a variety of ways. For example, as shown in FIG. 3b, the flexible material 28 can be disposed in holding slots 30 on the segments 14a-f. Alternatively, as shown in FIG. 3c, the flexible material 28 may include a side having an adhesive, which is used to adhere the thin flexible material 28 directly to the segments.

In a preferred embodiment, the holder 10 may further comprises a two-piece locking mechanism 20 positioned on adjacent segments 14a-f and distal to the hinge 18. The two-piece locking mechanism 20 is configured to selectively bind adjacent segments in their aligned position. The first piece 22 of the locking mechanism 20 is positioned on a first segment, and the second piece 24 is positioned on the adjacent segment. Preferably, the first piece 22 of locking mechanism 20 is a protrusion, and the second piece 24 is a depression configured to receive the protrusion. Although the two piece locking mechanism 20 is depicted as a protrusion/depression mechanism, those skilled in the art will recognize that any number two piece locking mechanisms, such as a latch or clasp, can be employed so long as the first piece 22 is on one segment 14c and the second piece 24 is on the adjacent segment 14b.

The example and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. Furthermore, the steps and number of the various steps illustrated in the figures may be adjusted from that shown. The accompanying figures and attachments illustrate exemplary embodiments of the invention.

Although the present invention has been described in terms of particular example and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

What is claimed is:

1. A key holder assembly, comprising:
a pair of adjacent segments, each segment defining at least one opening configured to receive and selectively retain a corresponding key in a series of graduated keys; and
a movable connection arranged on and extending along a longitudinal length of respective sidewalls of the adjacent segments to facilitate selective movement of the adjacent segments between an aligned position in which the respective sidewalls of the adjacent segments are parallel to each other, and an unaligned position in which the respective sidewalls of the adjacent segments are substantially perpendicular to each other.

2. The key holder of claim 1, wherein the movable connection comprises a hinge.

3. The key holder of claim 2, wherein the hinge is integrated directly into the sidewalls of the adjacent segments.

4. The key holder of claim 2, wherein edges of the sidewalls adjacent the hinge are beveled.

5. The key holder of claim 2, wherein the hinge is a bearing hinge.

6. The key holder of claim 1, wherein the movable connection comprises a pair of hinges arranged spaced apart along the longitudinal length of the respective sidewalls of the adjacent segments.

7. The key holder of claim 1, wherein the pair of hinges are aligned along the longitudinal length of the respective sidewalls of the adjacent segments.

8. The key holder of claim 1, wherein the adjacent segments includes a first segment defining an opening therethrough to receive and selectively secure a first key in the series of graduated keys therein.

9. The key holder of claim 8, wherein the adjacent segments includes a second segment defining an opening therethrough to receive and selectively secure a second key in the series of graduated keys therein,

10. The key holder of claim 9, wherein the second key is greater in size than the first key.

11. The key holder of claim 10, wherein the aligned position of the first segment and the second segment, a portion of the second key is cantilevered over a portion of the first key to block and prevent removal of the first key.

12. The key holder of claim 10, wherein the unaligned position, the first segment and the second segment are substantially perpendicular to one another to enable removal of the first key without interference from the second key.

13. The key holder of claim 8, further comprising a locking mechanism to selectively bind the adjacent segments in the aligned position.

14. The key holder of claim 13, wherein the locking mechanism is arranged on the adjacent segments distal to the movable connection.

15. The key holder of claim 13, wherein the locking mechanism comprises a first piece arranged on a front face of the second segment and a mating second piece arranged on a second sidewall of the first segment.

16. The key holder of claim 15, wherein the second sidewall is opposite to the sidewall upon which the movable connection is arranged.

17. The key holder of claim 15, wherein the first piece comprises a protrusion.

18. The key holder of claim 17, wherein the second piece comprises a depression configured to receive the protrusion.

19. A key holder assembly, comprising:
a plurality of segments configured to receive and retain a corresponding key in a series of graduated keys; and
a movable connection arranged on and extending along a longitudinal length of respective sidewalls of adjacent segments to facilitate selective movement of the adjacent segments between an aligned position in which the respective sidewalls of the adjacent segments are parallel to each other, and an unaligned position in which the respective sidewalls of the adjacent segments are substantially perpendicular to each other.

20. A key holder assembly, comprising:
at least two segments, each segment defining at least one opening configured to receive a corresponding key in a series of graduated keys;
a movable connection arranged on and extending along a longitudinal length of respective sidewalls of adjacent segments to facilitate selective movement of the adjacent segments between an aligned position in which the respective sidewalls of the adjacent segments are parallel to each other, and an unaligned position in which the respective sidewalls of the adjacent segments are substantially perpendicular to each other; and
a locking mechanism arranged on the adjacent segments and moveable between a locked state that maintains the adjacent segments in the aligned position, and an unlocked state that facilitate movement of the adjacent segments to unaligned position.
